(19) United States
(12) Patent Application Publication
(10) Pub. No.: US 2006/0256276 A1
(43) Pub. Date: Nov. 16, 2006

(54) Methods of fabricating liquid crystal displays

(75) Inventors: Yi-An Sha, Taipei City (TW); Chi-Chang Liao, Tainan (TW); Hsing-Lung Wang, Taoyuan County (TW); Jau-Min Ding, Taipei City (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/249,437

(22) Filed: Oct. 14, 2005

(30) Foreign Application Priority Data
May 10, 2005 (TW) 94115028

(51) Int. Cl. G02F 1/13; G02F 1/1333

(52) U.S. Cl. 349/187; 349/88

(57) ABSTRACT

Methods of fabricating liquid crystal displays. A substrate with a first electrode layer thereon is provided. A patterned barrier layer is formed to generate a plurality of pixel regions. A liquid crystal layer is filled into each pixel region. A monomer layer is filled into each pixel region over the liquid crystal layer. The monomer layer is polymerized to form a polymer layer phase separated from the liquid crystal layer.

### BACKGROUND

The invention relates to methods of fabricating liquid crystal displays, and more particularly, to methods of fabricating single substrate liquid crystal displays using inkjet printing and phase separation.

Liquid crystal displays typically exhibit excellent characteristics such as low power consumption, light weight, and good outdoor reliability, and are therefore widely applied in portable computer, notebook, mobile phone, and personal digital assistance (PDA), i.e., liquid crystal displays feature lighter weight, thinner profile, and increased portability. For example, Philips Inc. in society for information display (SID) discloses that flexibility is improved when total thickness of the liquid crystal display is reduced. Generally, when total thickness of the display is less than 400 μm, the display becomes flexible to bendable. Conventionally, thinner substrates and optic films or single substrate can reduce total thickness of the liquid crystal display.

FIG. 1 is a schematic view of a conventional method for fabricating a polymer dispersed liquid crystal display. A liquid crystal display is disposed in a ultra-violet light irradiation chamber 32. A power supply 32 applies a bias between an upper electrode 34 and a lower electrode 36. A liquid crystal layer 38 between the upper and lower electrodes 34, 36 comprises mixtures of liquid crystal and monomer. When the liquid display is irradiated by UV light, the monomer is polymerized to form a continuous network. Moreover, during polymerization, the orientation of the liquid crystal becomes more consistent with the polymer. After irradiation by UV light or thermal processing, the monomer in the liquid crystal layer 38 is polymerized, creating phase separation with the liquid crystal layer 38.

WO 02/48,282, the entirety of which is hereby incorporated by reference, discloses a single substrate formed by liquid crystal/polymer phase separation method. The method comprises mixing liquid crystal and monomer, and applying the mixture to a substrate, which is then irradiated by UV light, generating liquid crystal/polymer phase separation, and forming an in-plane switching (IPS) mode liquid crystal display. However, phase separation following mixing the liquid crystal and the monomer generates un-reacted monomer residue in the liquid crystal layer, affecting display quality.

### SUMMARY

The invention provides methods of fabricating single substrate liquid crystal display, using inkjet printing and implementing phase separation before polymeration.

The invention provides a method of fabricating a liquid crystal display comprising providing a substrate with a first electrode thereon, forming a patterned protruding structure on the substrate to generate a plurality of pixel regions, filling a liquid crystal layer in each pixel region, filling a monomer layer on the liquid crystal layer, and polymerizing the monomer layer into a polymer layer, implementing phase separation with the liquid crystal layer.

The invention also provides a method of fabricating a liquid crystal display comprising providing a substrate with a first electrode thereon, forming an alignment layer on the first electrode, forming a patterned protruding structure to generate a plurality of pixel regions, filling a liquid crystal layer in each pixel region, filling a monomer layer on the liquid crystal layer, polymerizing the monomer layer into a polymer layer, implementing phase separation with the liquid crystal layer, and forming a second electrode on the polymer layer.

### DESCRIPTION OF THE DRAWINGS

The invention will be better understood with reference to the descriptions to be read in conjunction with the accompanying drawings, in which:

FIG. 1 is a schematic view of a conventional method for fabricating a polymer dispersed liquid crystal display;

FIG. 2 is a cross section of an embodiment of a single substrate liquid crystal display using inkjet printing and liquid crystal/polymer phase separation according to the invention;

FIG. 3 is a flowchart of a method of fabricating a single substrate liquid crystal display according to the invention; and

FIGS. 4-6 are cross sections of methods for fabricating a single substrate liquid crystal display.

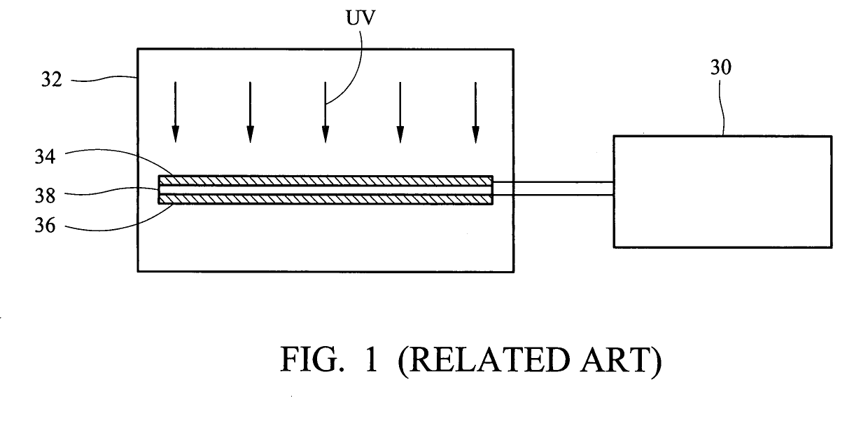

### DETAILED DESCRIPTION

The invention is directed to methods for fabrication of liquid crystal displays, by inkjet printing and liquid crystal molecular/polymer phase separation and have a single substrate structure, producing a bendable IPS mode liquid crystal display. Reference will now be made in detail to the preferred embodiments of the invention, examples of which are illustrated in the accompanying drawings.

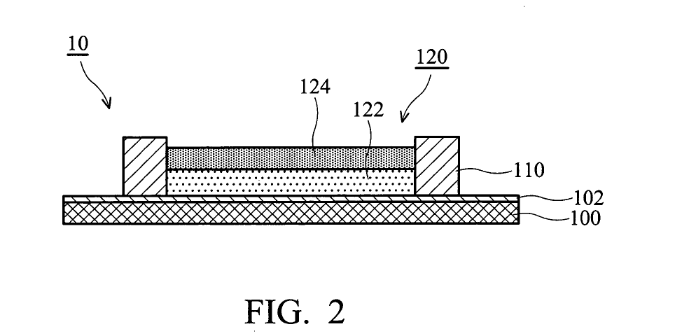

FIG. 2 is a cross section of an embodiment of a single substrate liquid crystal display fabricated by inkjet printing and liquid crystal/polymer phase separation according to the invention. In FIG. 2, a single substrate liquid crystal display 10 comprises a substrate 100 with a first electrode thereon. An alignment layer is formed on the substrate 100. A patterned protruding structure 110 is formed on the substrate 100 to divide a plurality of pixel regions 120. A liquid crystal layer 122 is filled in each pixel region 120. A polymer layer 124 is formed on the liquid crystal layer 122 by polymerizing a monomer layer, implementing phase separation with the liquid crystal layer.

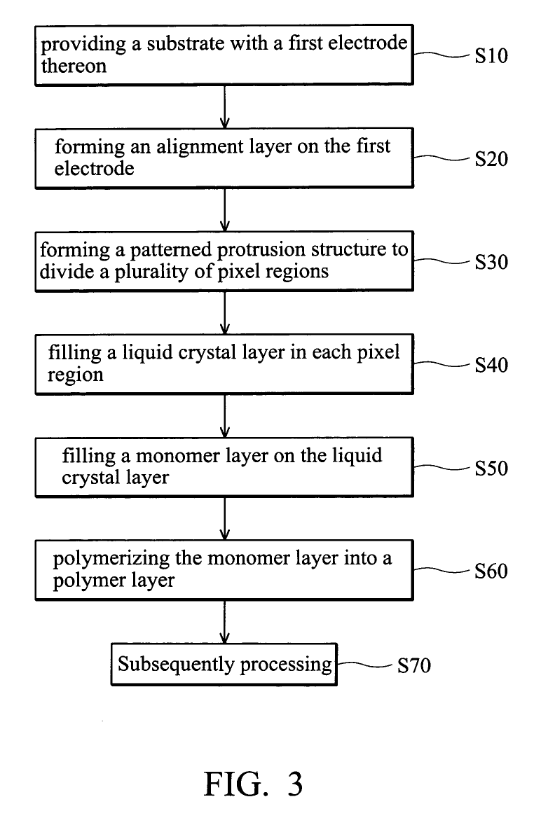

FIG. 3 is a flowchart of a method of fabricating a single substrate liquid crystal display 10 according to the invention. A substrate with a first electrode thereon is provided (S10). An alignment layer is formed on the first electrode (S20). The alignment layer may comprise polyvinyl alcohol (PVA), polyimide (PI), polyamide (PA), polyurea (PU), nylon, or lecithin. A patterned protruding structure is formed on the alignment layer to generate a plurality of pixel regions (S30). A liquid crystal layer is filled in each pixel region (S40), by inkjet injection. A monomer layer is filled on the liquid crystal layer (S50). The monomer layer is then polymerized into a polymer layer, implementation phase separation with the liquid crystal layer (S50). After subsequent processing, such as connection of a control circuit, or packaging the liquid crystal display, fabrication is complete.

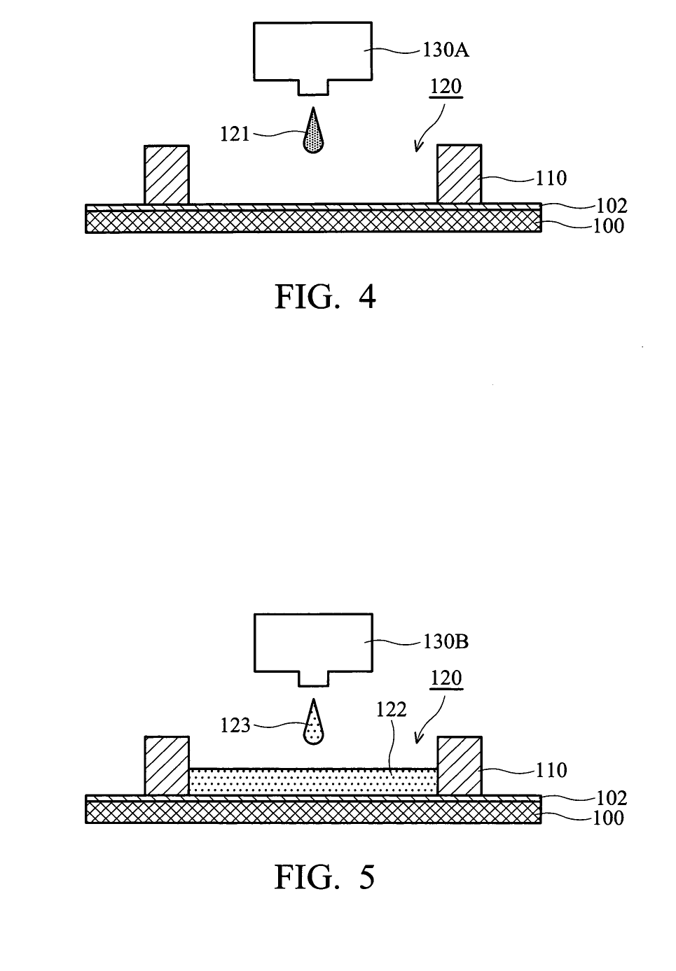

FIGS. 4-6 are cross sections of methods for fabricating a single substrate liquid crystal display. Referring to FIG. 4, a substrate 100 with a first electrode thereon is provided. The substrate 100 may comprise a glass substrate, a metal substrate, or a polymer substrate. Alternatively, the substrate may comprise an active matrix array substrate such as thin film transistor (TFT) or thin film diode (TFD). The first electrode may comprise organic conductive material or inorganic conductive material. The first electrode may comprise a plurality of parallel electrodes or a pair of finger-comb shape electrodes to form lateral electric field, or in-plane switching (IPS) field. While this embodiment has been described in conjunction with an example of an in-plane switching (IPS) mode liquid crystal display, the features of this embodiment may also be applied to an active matrix liquid crystal display using a twist nematic mode or a cholesteric mode liquid crystal display.

An alignment layer 102 is sequentially formed overlying the substrate 100. The alignment layer 102 may comprises polyvinyl alcohol (PVA), polyimide (PI), polyamide (PA), polyurea (PU), nylon, or lecithin. A patterned protruding structure 110 is formed on the alignment layer 102 to generate a plurality of pixel regions 120. The protruding structure 110 may be formed by lithography, printing, or spraying.

Next, a liquid crystal layer 122 is filled in each pixel region 120, preferably by inkjet printing. For example, a printhead 130A, such as thermal bubble driven inkjet printhead or piezoelectric diaphragm driven inkjet printhead, can inject droplets 121 of liquid crystal material into each pixel region 120, thereby forming a liquid crystal layer 122 therein. The liquid crystal layer 122 can comprise a twist nematic liquid crystal, a cholesteric liquid crystal, a sematic liquid crystal, a disk-shape liquid crystal, or a liquid phase liquid crystal. The specific weight of the liquid crystal layer is approximately 0.7-1.5 g/cm³.

Moreover, the invention provides optional different optical characteristics depending on different liquid crystal materials. For example, using different reflection of cholesteric liquid crystals can fabricate full color cholesteric mode liquid crystal displays.

Referring to FIG. 5, a monomer layer is formed on the liquid crystal 122 in each pixel region 120 by inkjet printing. For example, a printhead 130B, such as thermal bubble driven inkjet printhead or piezoelectric diaphragm driven inkjet printhead, can inject droplets 123 of monomer material into each pixel region 120, thereby spontaneously forming liquid crystal layer/monomer layer phase separation in each pixel region 120. The monomer may comprise diacrylate, monocrylate, or other single functional/bi-functional monomers. The monomer layer is sequentially polymerized by radiant polymerization, thermal polymerization, or radical polymerization. After activating by irradiation, the monomer is photo-dissociated into radicals and interacts with other radicals, thereby polymerizing a polymer layer. An optional initial may be added into the monomer layer. The specific weight of the monomer layer is approximately 0.5-1.7 g/cm³.

Since the liquid crystal layer 122 and the monomer layer are formed indifferent inkjet printing steps and with different specific weights, spontaneous phase separation thus occurs between the liquid crystal layer 122 and the monomer layer. Alternatively, the liquid crystal layer 122 and the monomer layer can be selected of different polarities to form spontaneous phase separation.

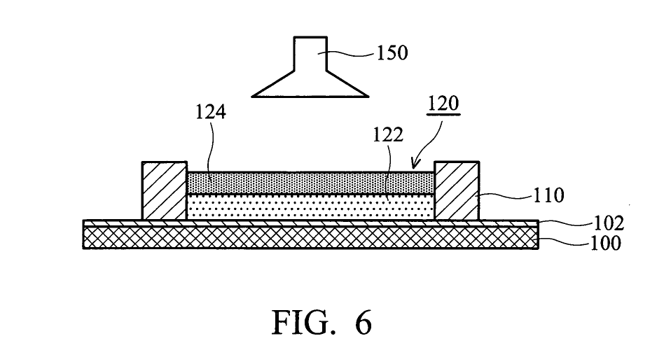

Referring to FIG. 6, the monomer layer is polymerized into a polymer layer 124, implementing phase separation with the liquid crystal layer 122. Polymerization may comprise radiant, thermal, or radical polymerization. For example, if substrate 100 with a monomer layer thereon is disposed in a UV radiation chamber, after UV radiation, the monomer layer is polymerized into a polymer layer. An optional bias can be applied on the monomer layer during UV irradiation.

After subsequent processing steps, such as forming a second electrode and color filter (not shown) on the polymer layer 124, and connecting controlling circuit, or packaging of the liquid crystal display, the single substrate liquid crystal display is complete.

Accordingly, the invention is advantageous over conventional methods in that injection of the liquid crystal layer and the monomer layer are performed at different steps, spontaneously implementing phase separation between the liquid crystal layer and the monomer layer. The monomer layer can be completely polymerized with no unreacted monomer residue in the liquid crystal layer, improving display quality. Moreover, the polymer layer can serve as a passvation layer on the liquid crystal layer, providing single substrate structure with excellent bendability. Furthermore, using different reflection of cholesteric liquid crystals corresponding to different pixel regions can fabricate full color cholesteric mode liquid crystal displays.

While the invention has been described by way of example and in terms of preferred embodiment, it is to be understood that the inventions is not limited thereto. To the contrary, it is intended to cover various modifications and similar arrangements (as would be apparent to those skilled in the art). Thus, the scope of the appended claims should be accorded the broadest interpretations so as to encompass all such modifications and similar arrangements.

What is claimed is:

1. A method of fabricating a liquid crystal display, comprising:
providing a substrate with a first electrode thereon;
forming a patterned protruding structure on the substrate to generate a plurality of pixel regions;
filling a liquid crystal layer in each pixel region;
filling a monomer layer on the liquid crystal layer; and
polymerizing the monomer layer into a polymer layer, implementing phase separation with the liquid crystal layer.

2. The method as claimed in claim 1, wherein the substrate comprises a glass substrate, a metal substrate, or a polymer substrate.

3. The method as claimed in claim 1, wherein the substrate comprises an active matrix array substrate.

4. The method as claimed in claim 1, wherein the first electrode comprises organic conductive material or inorganic conductive material.

5. The method as claimed in claim 1, wherein the first electrode comprises a plurality of parallel electrodes or a pair of finger-comb shape electrode to form lateral electric field.

6. The method as claimed in claim 1, further comprising forming an alignment layer on the first electrode.

7. The method as claimed in claim 6, wherein the alignment layer comprises polyvinyl alcohol (PVA), polyimide (PI), polyamide (PA), polyurea (PU), nylon, or lecithin.

8. The method as claimed in claim 1, wherein the protruding structure is formed by lithography, printing, or spraying.

9. The method as claimed in claim 1, wherein the liquid crystal layer is formed by inkjet printing.

10. The method as claimed in claim 1, wherein the liquid crystal layer comprises a twist nematic liquid crystal, a cholesteric liquid crystal, a sematic liquid crystal, a disk-shape liquid crystal, or a liquid phase liquid crystal.

11. The method as claimed in claim 1, wherein the specific weight of the liquid crystal layer is approximately 0.7-1.5 g/cm³.

12. The method as claimed in claim 1, wherein the monomer layer is formed by inkjet printing.

13. The method as claimed in claim 1, wherein polymerization of the monomer layer comprises radiant polymerization, thermal polymerization, or radical polymerization.

14. The method as claimed in claim 1, wherein the specific weight of the monomer layer is approximately 0.5-1.7 g/cm³.

15. The method as claimed in claim 1, further comprising forming a second electrode on the polymer layer.

16. A method of fabricating a liquid crystal display, comprising:
providing a substrate with a first electrode thereon;
forming an alignment layer on the first electrode;
forming a patterned protruding structure on the substrate to generate a plurality of pixel regions;
filling a liquid crystal layer in each pixel region;
filling a monomer layer on the liquid crystal layer;
polymerizing the monomer layer into a polymer layer, implementing phase separation with the liquid crystal layer; and
forming a second electrode on the polymer layer.

17. The method as claimed in claim 16, wherein the substrate comprises an active matrix array substrate.

18. The method as claimed in claim 16, wherein the first electrode comprises a plurality of parallel electrodes or a pair of finger-comb shape electrode to form lateral electric field.

19. The method as claimed in claim 16, wherein the alignment layer comprises polyvinyl alcohol (PVA), polyimide (PI), polyamide (PA), polyurea (PU), nylon, or lecithin.

20. The method as claimed in claim 16, wherein the protrusion structure is formed by lithography, printing, or spraying.

21. The method as claimed in claim 16, wherein the liquid crystal layer comprises a twist nematic liquid crystal, a cholesteric liquid crystal, a sematic liquid crystal, a disk-shape liquid crystal, or a liquid phase liquid crystal.

22. The method as claimed in claim 16, wherein the specific weight of the liquid crystal layer is approximately 0.7-1.5 g/cm³.

23. The method as claimed in claim 16, wherein polymerization of the monomer layer comprises radiant polymerization, thermal polymerization, or radical polymerization.

24. The method as claimed in claim 16, wherein the specific weight of the monomer layer is approximately 0.5-1.7 g/cm³.
